(19) United States
(12) Patent Application Publication
(10) Pub. No.: US 2004/0036693 A1
(43) Pub. Date: Feb. 26, 2004

(54) Method for representing a color paper mosaic using computer

(76) Inventors: Kyung-Hyun Yoon, Seoul (KR); Cheung Woon Jho, Bucheon-Si (KR); Young-Sup Park, Seoul (KR); Sang-Hyun Seo, Seoul (KR); Sung-Ye Kim, Daejeon (KR)

Correspondence Address: G W I P S, Kangnam, PO Box 2301, Seoul, 135 242, KR

(21) Appl. No.: 10/250,336

(22) PCT Filed: Jul. 10, 2001
(86) PCT No.: PCT/KR01/01177

(30) Foreign Application Priority Data
Jan. 12, 2001 (KR) 2001/1789

(51) Int. Cl. G09G 5/00

(52) U.S. Cl. 345/582

(57) ABSTRACT

Disclosed is a method for representing a colored paper mosaic image using a computer. The method involves receiving an inputted image from a user, producing a paper texture, producing random polygons based on the inputted image and applying the paper texture to the polygons, respectively, and representing a mosaic image having white portions corresponding to torn portions of manually torn colored paper and edges with a ragged shape corresponding to the torn edges of torn colored paper, to obtain the same effect as that obtained by manually produced mosaics. This method makes it possible to more realistically represent colored paper mosaic images as compared with those represented using conventional computer graphics drafting tools. Where the method of the present invention is added as a plug-in to a graphics drafting tool such as Photoshop or Paintshop, it is possible to represent, for all images produced using computer graphics tools, the same mosaic effect as that obtained when colored paper is manually torn.

### BACKGROUND OF THE INVENTION

1. Field of the Invention

The present invention relates to a method for representing a colored paper mosaic image using a computer, and more particularly to a method for representing a colored paper mosaic image by implementing an image mosaicing scheme using a computer, thereby obtaining the same effect as that obtained by using a manual mosaicing method.

2. Related Prior Art

Non-photorealistic rendering (NPR) is known as a general method for representing, on a computer, a manually produced artistic image. The NPR scheme is an image-rendering method aimed at rendering artistic expressions of artists. In this regard, the NPR scheme may simply be defined as a “means for producing images not intended to portray realism.”

Such an NPR scheme may be mainly classified as a 2D brush-painting scheme and a 2D/2.5D post-processing scheme. Active research has been undergone to develop NPR schemes associated with the post-processing of 3D models. In particular, recent increased interest in NPR schemes has resulted in development of diverse computer graphics tools capable of representing, on a computer, artistic images produced in accordance with a traditional genre such as a watercolor painting scheme or an impressionistic painting scheme.

However, where a mosaicing scheme is implemented using the above-mentioned computer graphics tools to render mosaic images of colored paper frequently used in the education of children, there is a problem. Although it is possible to render colored paper mosaic images with sharp edges—a graphic effect that simulates the effect obtained when colored paper is cut using a tool such as a blade or scissors—it is impossible to render colored paper mosaic images having a graphic effect that simulates the effect obtained when colored paper is manually torn to produce ragged edges.

### SUMMARY OF THE INVENTION

Therefore, the present invention has been made in view of the above-mentioned problem, and an objective of the invention is to provide a method for representing a colored paper mosaic image by implementing an image mosaicing scheme using a computer, thereby obtaining the same effect as that obtained by a manual mosaicing method.

In accordance with the present invention, this objective is accomplished by providing a method for representing a colored paper mosaic image using a computer, comprising the following steps: receiving an inputted image from a user; producing a paper texture; producing random polygons based on the inputted image, and applying the paper texture to the polygons, respectively; and representing a mosaic image having white portions corresponding to torn portions of manually torn colored paper, and edges with a ragged shape corresponding to torn edges of torn colored paper, to obtain the same effect as that obtained by manual mosaics.

### BRIEF DESCRIPTION OF THE DRAWINGS

The above objectives, and other features and advantages of the present invention, will become more apparent after a reading of the following detailed description taken in conjunction with the drawings, in which:

FIG. 1 is a flowchart illustrating a colored paper mosaic image produced using a PC in accordance with the present invention;

FIG. 2 is a view illustrating examples of paper textures produced using the Perlin's noise function;

FIG. 3 is a view illustrating the production of polygons;

FIG. 4 is a view illustrating an image produced in accordance with an automatic polygon-producing scheme;

FIG. 5 is a view illustrating the production of random polygons based on the image inputted by the user and the application of textures to the produced polygons;

FIG. 6 is a view illustrating a method for representing a natural colored paper mosaic image;

FIG. 7 is a view illustrating the structure of a colored paper image for representing the white portions of torn paper;

FIG. 8a is a view illustrating a colored paper image produced only when a random function is applied;

FIG. 8b is a view illustrating a colored paper image produced using a random intermediate point extraction method;

FIG. 9a is a view illustrating an image of manually produced colored paper mosaics; and

FIG. 9b is a view illustrating a colored paper mosaic image produced in accordance with the present invention.

### DETAILED DESCRIPTION OF THE PREFERRED EMBODIMENT

Now, preferred embodiments of the present invention will be described in conjunction with the annexed drawings.

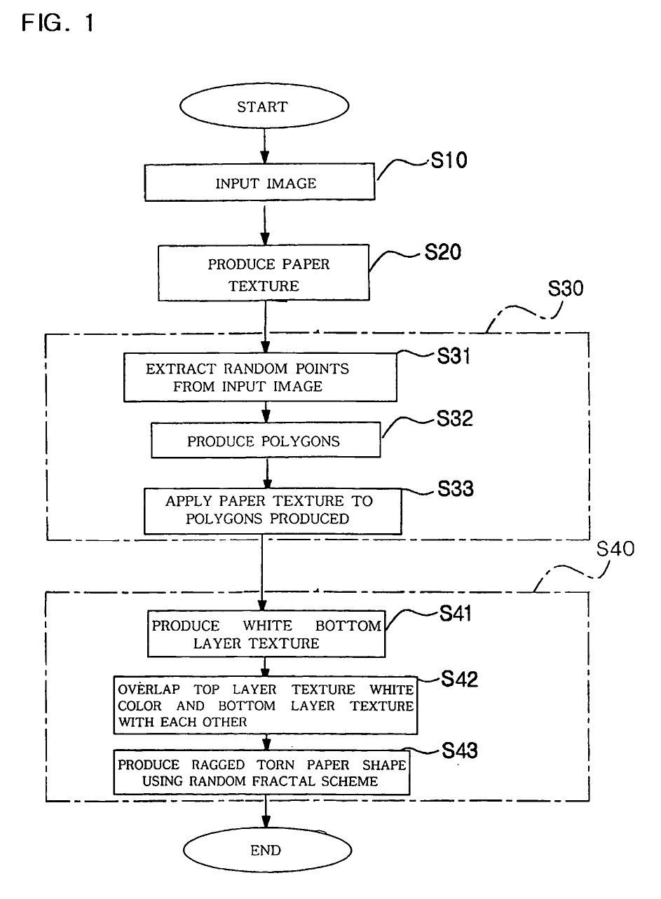

FIG. 1 is a flowchart illustrating a colored paper mosaic image produced using an embodiment of the present invention. This method will be described in conjunction with respective processing steps thereof.

(1) Image Inputting Step (Step S10)

First, an image to be represented in the form of mosaics is inputted. The inputted image may be an image produced using a PC or an image produced by scanning a manually produced image that is then converted into a digital image.

(2) Paper Texture Generating Step (Step S20)

The most important properties of paper represented in computer graphics are texture and optical property. Since paper is an aggregate of numerous fibers, its characteristics are determined by connection relationships among fibers, forming horizontal and vertical textures. Additionally, paper is composed of textures of several plies. The optical property of paper allows the viewer to experience various visual perceptions in accordance with the interaction between the paper and light, and may include characteristics such as color, brightness, opacity, and gloss. The influence of light on the visual response is limited to visible rays, and the visual response may be diversely affected by controlling the light absorption, reflection and transmission phenomena occurring in the material of the paper. Thus, the interaction between the paper and light may be controlled in accordance with a surface treatment of the paper.

At this processing step, a paper texture is produced using the Perlin's noise function; that is, by generating tangential vectors based on the value of an optional coordinate of the inputted image and the value of the Perlin's noise function at that coordinate under the condition in which only values of height are applied (provided the height h of each pixel in the paper is adjusted within a range of “0<h<1”), and positioning a light source at an optional position, thereby shading the paper surface (Step S20).

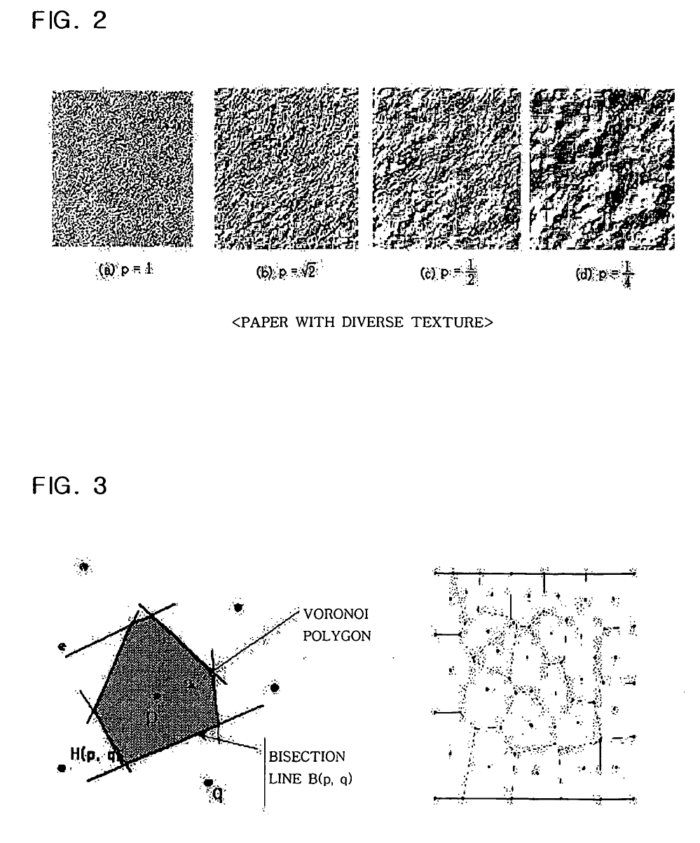

FIG. 2 illustrates examples of paper textures produced using the Perlin's noise function.

(3) Polygon-Producing Step (Step S30)

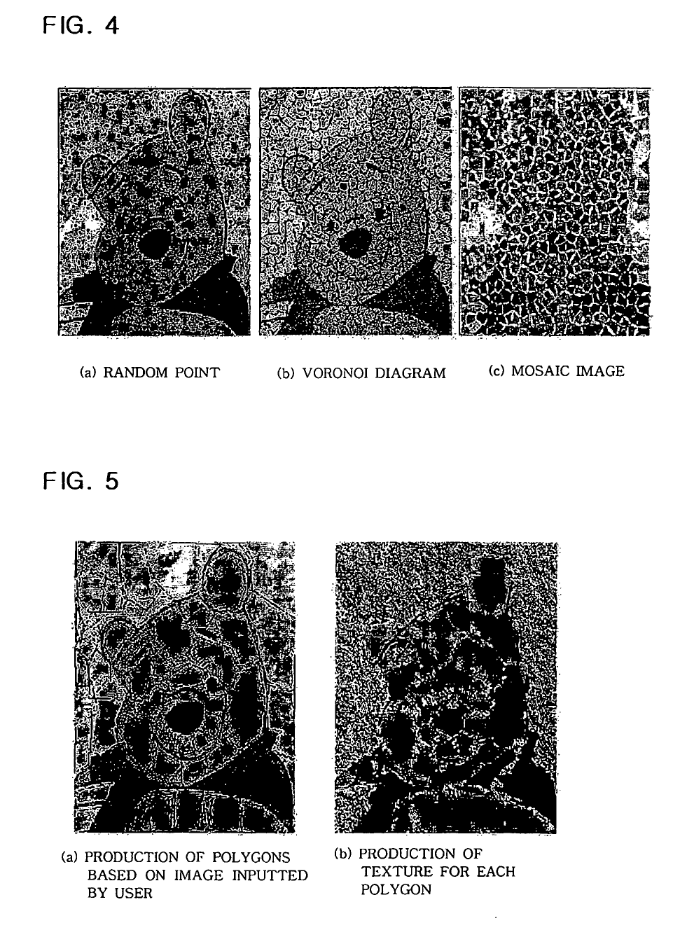

FIG. 3 is a view illustrating the production of polygons. FIG. 4 is a view illustrating an image produced in accordance with an automatic polygon-producing scheme. FIG. 5 is a view illustrating the production of random polygons based on the image inputted by the user and the application of textures to the produced polygons.

The shapes of manually torn paper occur randomly. Accordingly, random points are extracted from the image inputted by the user in accordance with the present invention (Step S31). A Voronoi diagram is then applied to the extracted points, thereby producing Voronoi polygons. Based on feature edges extracted from the inputted image, along with the Voronoi polygons, desired polygons are produced (Step S32). Thereafter, the produced texture is applied to the produced polygons (Step S33).

(4) Mosaic Image Representing Step (Step S40)

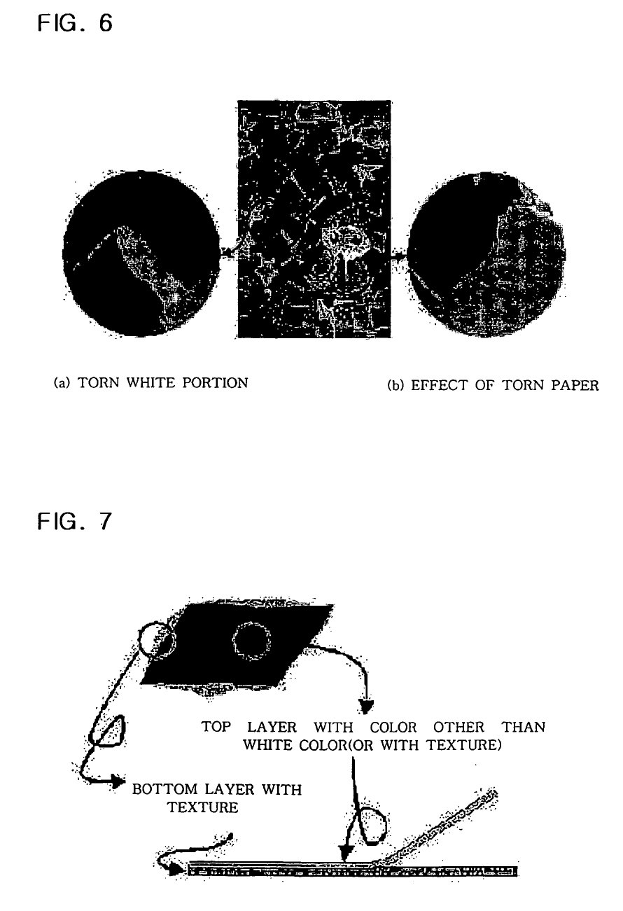

FIG. 6 is a view illustrating a method for representing a natural colored paper mosaic image.

When colored paper is manually torn, white color is visible at torn portions of the colored paper by virtue of the features of paper. Also, the torn colored paper has ragged edges. In order to obtain the same effect as that obtained when a manual mosaicing is carried out, therefore, it is necessary to represent white color at the torn portions of colored paper, as shown in FIG. 6a, while representing a ragged shape at the torn edges of colored paper, as shown in FIG. 6b.

a) Representation of White Portions of Torn Paper

FIG. 7 is a view illustrating the structure of a colored paper image representing the white portions of torn paper. It is assumed that the colored paper image is composed of paper textures of two plies.

In order to represent the white torn paper portions, two paper textures are produced in such a fashion that one of the paper textures has a white color and the other paper texture has a color other than white, with an area smaller than that of the white paper texture (Step S41). These paper textures are then overlapped to form a laminated paper texture structure of two plies in which the white paper texture forms a bottom layer and the paper texture having a color other than white color forms a top layer (Step S42).

As shown in FIG. 7, the bottom layer thereof is a white layer basically having the features of the paper texture produced at Step S20. This bottom layer corresponds to the paper portion represented by white color when colored paper is torn. On the other hand, the top layer may have an optional color other than white color. This top layer may or may not have a paper texture feature in accordance with the selection of the user.

As also shown in FIG. 7, the colored paper image is composed of two laminated paper layers. Since the bottom layer is larger than the top layer, the colored paper image represents white paper portions formed when colored paper is manually torn.

b) Representation of Ragged Shape at Torn Edges of Colored Paper

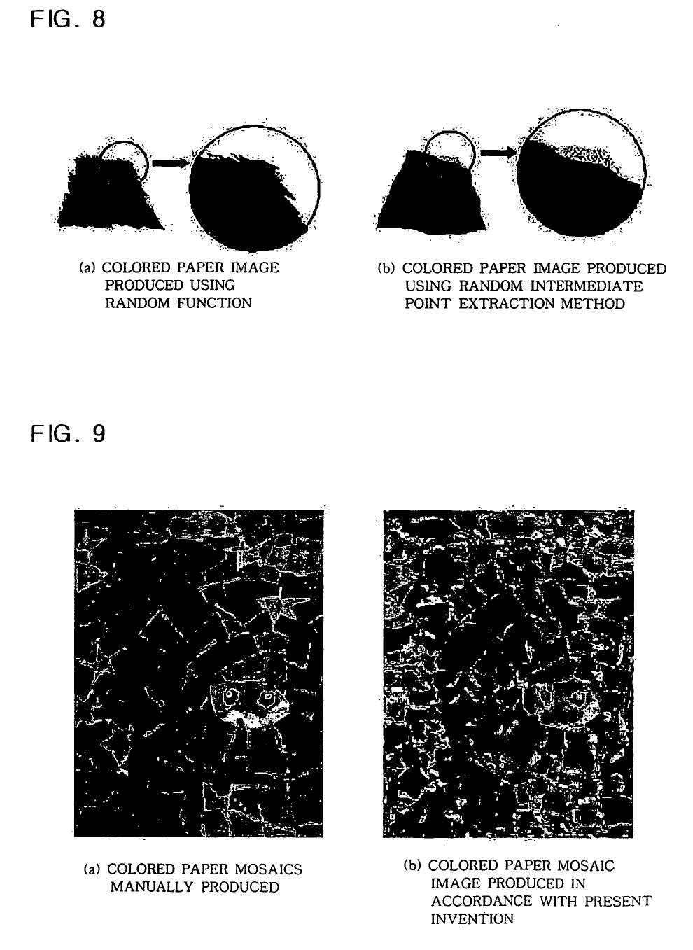

FIG. 8a is a view illustrating a colored paper image produced only when a random function is applied. FIG. 8b is a view illustrating a colored paper image produced using a random intermediate point extraction method.

Manually torn paper has a ragged or irregular shape. In order to represent such a ragged shape, it is necessary to add random height to a line connecting two points (that is, the start and end points of the line). However, the result obtained in accordance with a simple addition of random values is very different from that obtained when paper is manually torn.

In order to obtain more realistic results, therefore, the representation of a ragged paper shape is made using a random intermediate point extraction method involving the extraction of the intermediate point of a line connecting two points and the addition of random height to the extracted intermediate point in a direction perpendicular to the line (Step S43).

The random intermediate point extraction method is a random fractal scheme. In accordance with this method, the intermediate point of a line connecting two lines is extracted. The intermediate point divides the line into two segments. Random height (a positive number or negative number) is added to the extracted intermediate point in a direction perpendicular to the line. This procedure is repeatedly executed. As the number of divisions increases, the range of random values to be added is reduced. That is, the range of random values to be respectively added to intermediate points is reduced in a ratio of (½)h (where “h” represents the number of divisions). In accordance with this method, it is possible to represent a ragged torn paper shape similar to that obtained when colored paper is manually torn, as shown in FIG. 8b.

FIG. 9a is a view illustrating an image of manually produced colored paper mosaics. FIG. 9b is a view illustrating a colored paper mosaic image produced in accordance with the present invention. Although several minutes or several ten-minute intervals are required to obtain the result shown in FIG. 9a, it is possible to produce a colored paper mosaic image according to user preference within a reduced period of time in accordance with the present invention.

As apparent from the above description, and in accordance with the present invention, it is possible to more realistically represent colored paper mosaic images, as compared to those represented using conventional computer graphics drafting tools. Where the present invention is added as a plug-in to a graphics drafting tool such as Photoshop or Paintshop, it is possible to represent, for all images produced using computer graphics tools, the same mosaic effect as that obtained when colored paper is manually torn.

The colored paper mosaic scheme frequently used in the education of children can be implemented using a computer in accordance with the present invention. Accordingly, the present invention can be very useful to applications for education requiring visual effects.

Although the preferred embodiments of the invention have been disclosed for illustrative purposes, those skilled in the art will appreciate that various modifications, additions and substitutions are possible without departing from the scope and spirit of the invention as disclosed in the accompanying claims.

1. A method for representing a colored paper mosaic image using a computer, comprising the steps of:
receiving an input image from a user;
producing a paper texture;
producing random polygons based on the input image, and applying the paper texture to the polygons, respectively; and
representing a mosaic image having white portions corresponding to torn portions of colored paper, manually torn to form mosaics, and edges with a ragged shape corresponding to torn edges of the torn colored paper, to obtain the same effect as that obtained by the mosaics.

2. The method according to claim 1, wherein the paper texture producing step comprises the steps of:
generating tangential vectors based on a value of a selected coordinate on the input image and a value of the Perlin's noise function at the coordinate under a condition in which respective heights (h) of pixels composing paper are applied (0<h<1);
positioning a light source at an optional position; and
shading the paper surface based on the light, thereby producing a paper texture.

3. The method according to claim 1, wherein the polygon producing step comprises the steps of:
extracting random points from the input image;
applying a Voronoi diagram to the extracted points, thereby producing Voronoi polygons, and producing polygons based on feature edges extracted from the input image along with the Voronoi polygons, respectively; and
applying the paper texture to the produced polygons.

4. The method according to claim 1, wherein the mosaic image representing step comprises the steps of:
producing two paper textures so that one of the paper textures has white color whereas the other paper texture has a color other than white color while having an area smaller than that of the white paper texture, to represent the white torn paper portions, and overlapping the paper textures with each other to form a laminated paper texture structure of two plies in which the white paper texture forms a bottom layer whereas the paper texture having a color other than white color forms a top layer; and
representing the ragged paper shape using a random intermediate point extraction method involving an extraction of an intermediate point of a line connecting two points and an addition of a random height to the extracted intermediate point in a direction perpendicular to the line.

5. A recording medium readable by a computer loaded with a program for executing the colored paper mosaic image representing method according to claim 1.
